(19) United States
(12) Patent Application Publication
(10) Pub. No.: US 2018/0010622 A1
(43) Pub. Date: Jan. 11, 2018

(54) CONNECTION CLAMP

(71) Applicant: CHEN-SOURCE INC., Taoyuan City (TW)

(72) Inventor: Kuan-Yen WU, Taoyuan City (TW)

(21) Appl. No.: 15/202,907

(22) Filed: Jul. 6, 2016

(51) Int. Cl. F16B 2/10; F16M 13/02; A47B 97/00; H04M 1/04

(52) U.S. Cl. CPC F16B 2/10; H04M 1/04; F16M 13/022; A47B 97/00; A47B 2097/005; A47B 2097/006

(57) ABSTRACT

A connection clamp includes a base member defining an operating space in a front side thereof and two bearing surfaces at two opposite lateral sides relative to the operating space, and a clamping mechanism including two clamping members of V-shaped cross section pivotally mounted in the operating space with an axle and a spring member mounted on the axle with two opposing angled end pieces respectively fastened to the clamping members to force the clamping plates into abutment against the respective bearing surfaces of the base member for clamping two flat mobile electronic devices to hold them side by side in the same plane.

### BACKGROUND OF THE INVENTION

### 1. Field of the Invention

The present invention relates to clamps and more particularly, to a connection clamp, which comprises a base member having two bearing surfaces bilaterally located on a front side thereof, and a clamping mechanism comprising two clamping members pivotally connected to the base member and respectively clamped on the two bearing surfaces to secure one flat mobile electronic device to another flat mobile electronic device side by side.

### 2. Description of the Related Art

With fast development of technologies, advanced and sophisticated electrical and electronic devices have been continuously created and widely used by people, bringing convenience in many aspects of outer daily lives. In addition to home appliances, kitchen appliances and other workplace or business machines, etc., almost every busy modern people will use electrical and/or electronic devices daily, saving a lot of time in daily works and significantly enhancing the efficiency of work and study. Nowadays, desktop computer, notebook computer, tablet, smart phone, GPS device and many other mobile electronic devices are frequently used in our everyday life or work for word processing operations, drawing and photo editing and production, video and audio transmission or satellite positioning and navigation. By means of the Internet, wireless signal transmission or satellite signal transmission, etc., modern mobile electronic devices can be conveniently used regardless of time and place restrictions. In order to facilitate convenient use and to save storage space, advanced electrical and electronic devices commonly have light, thin, short and small characteristics. Commercial electronic display devices (TV or desktop computer screens), notebook computers, tablet PCs, smart phones, personal digital assistants (PDAs) and many other satellite positioning and navigation devices common use a LCD, plasma or touch screen for displaying images. These display devices commonly exhibit a flat panel design having light and thin characteristics. In application, these display devices require less installation. For the advantages of space saving, these display devices have become the most widely used electronic and electrical products.

The screen of a TV, desktop computer or notebook computer is integrated in a mainframe or base member that can support the screen in vertical. However, regular screen-incorporated mobile electronic device such as tablet computer, smart phone, PDA or GPS navigation device commonly have a flat panel design. When using a regular screen-incorporated mobile electronic device, the user must hold the device in hand. The advantage of ease of use of mobile electronic devices causes many people addict to using mobile electronic devices. People of silver-haired groups or middle-aged groups, office workers or students may use more than one mobile electronic device daily. For example, one can have two or more than two flat-panel mobile electronic devices in hand, such as notebook computer, tablet computer, smart phone, GPS navigation device, PDA and other flat-panel mobile electronic devices. However, flat-panel mobile electronic devices are to be used on the user's hands. People cannot conveniently use two flat-panel mobile electronic devices on the hands at a time. When using two flat-panel mobile electronic devices, the user can simply hold one flat-panel mobile electronic device in hand and operate it, and then put the flat-panel mobile electronic device on a flat surface, and then pick up the other flat-panel mobile electronic device for operation. For modern people who emphasize realistic practicality, time saving and efficiency in their daily life, it is quite inconvenient to simultaneously control multiple flat-panel mobile electronic devices in this manner. There are still a lot of inconvenience and drawbacks for improvement.

Further, with the advances in communications industry, not only desktop computer, tablet computer, smart phone, etc. can be linked to the Internet by means of wireless communication (4G or Wi-Fi, etc.) or satellite communication, many flat-panel television screens also provide an Internet connection application function so that they can be used as a computer screen. Many people are like to connect a desktop computer or TV to the Internet for application; however, they cannot attach a mobile electronic device to the desktop computer or TV for synchronous application to satisfy their application requirements. Further, when carrying or storing multiple flat-panel mobile electronic devices, people normally will arrange the flat-panel mobile electronic devices in a stack to reduce the occupational space. However, when carrying multiple flat-panel mobile electronic devices in a stack, the flat-panel mobile electronic devices can rub against one another, causing friction scratches.

Therefore, it is desirable to provide a measure that facilitates convenient use and storage of multiple flat mobile electronic devices.

### SUMMARY OF THE INVENTION

The present invention has been accomplished under the circumstances in view. It is the main object of the present invention to provide a connection clamp, which is convenient in use and practical for securing two flat electronic devices side by side in the same plane.

To achieve this and other objects of the present invention, a connection clamp comprises a base member and a clamping mechanism. The base member defines an operating space on the front side thereof, and two bearing surfaces at two opposite lateral sides relative to the operating space. The clamping mechanism comprises two clamping members of V-shaped cross section pivotally mounted in the operating space with an axle, and a spring member mounted on the axle with two opposing ends thereof respectively fastened to the clamping members to force the clamping plates into abutment against the respective bearing surfaces of the base member. Further, each clamping member comprises a clamping plate forced by the spring member to clamp on one respective bearing surface of the base member, and an operating plate extended from the clamping plate at a predetermined angle and operable to bias the clamping plate away from the respective bearing surface. Thus, the clamping members can clamp the two bearing surfaces of the base member on two flat mobile electronic devices to hold the two flat mobile electronic devices side by side in the same plane so that the user can simultaneously watch the screens of the two flat mobile electronic devices.

Further, the base member comprises a bracket located on the front side thereof. The operating space is defined in the bracket. The axle of the clamping mechanism is inserted through the spring member, having two end portions respectively extended out of the opposing top and bottom sides of the spring member and respectively connected to the opposing top and bottom sides of the bracket. Further, the bracket comprises a supporting rod and a supporting block respectively perpendicularly extended from the front side of the base member at opposing top and bottom sides relative to the operating space, two axle holes respectively vertically located on the supporting rod and the supporting block and axially aligned in line, and a U-shaped connection member connected to the supporting rod and the supporting block. Further, the axle is connected between the supporting rod and the supporting block with the two end portions thereof respectively fastened to the two axle holes. Further, the U-shaped connection member comprises two connection end pieces respectively extended from opposing top and bottom sides thereof and respectively fastened to the supporting rod and the supporting block by means of a dovetail joint, tongue and groove joint, tenon and mortise joint or tight-fitting joint, and an anti-slip stripe design located on two opposite lateral sides thereof.

Further, the base member comprises a rectangular bearing panel, a flat and elongated face panel extended from a middle part of a bottom side of the rectangular bearing panel in a flush manner so that the combination of the rectangular bearing panel and the flat and elongated face panel exhibits a planar key-like shape, and a decorative design of graphics, lines, and/or geometric pattern located on the back side of the rectangular bearing panel and the back side of the flat and elongated face panel.

Further, the clamping members of the clamping mechanism have a substantially V-shaped cross section. Each clamping member defines a mounting space on the back side on the middle for accommodating the spring member. Each clamping member further comprises two pivot holes respectively disposed at the opposing top and bottom sides of the mounting space, and a hook hole located on the operating plate. The two end portions of the axle are respectively pivotally inserted through the two pivot holes of each clamping member and respectively fastened to the base member to pivotally connect the two clamping members to the base member. Further, the spring member is mounted around the axle in the mounting space of each clamping member, comprising two angled end pieces respectively extended from two opposite ends thereof in reversed directions and respectively hooked in the hook holes of the two clamping members.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a connection clamp in accordance with a first embodiment of the present invention.

FIG. 2 corresponds to FIG. 1 when viewed from another angle.

FIG. 3 is an exploded view of the connection clamp in accordance with the first embodiment of the present invention.

FIG. 4 corresponds to FIG. 3 when viewed from another angle.

FIG. 5 is a sectional side view of the connection clamp in accordance with the first embodiment of the present invention.

FIG. 6 is a top view of the connection clamp in accordance with the first embodiment of the present invention.

FIG. 7 is a schematic top view of the first embodiment of the present invention, illustrating the two clamping members biased relative to the base member.

FIG. 8 illustrates an application example of the connection clamp in accordance with the first embodiment of the present invention.

FIG. 9 illustrates another application example of the connection clamp in accordance with the first embodiment of the present invention.

FIG. 10 illustrates still another application example of the connection clamp in accordance with the first embodiment of the present invention.

FIG. 11 is an exploded view of a connection clamp in accordance with a second embodiment of the present invention.

FIG. 12 illustrates an application example of the connection clamp in accordance with the second embodiment of the present invention (I).

FIG. 13 illustrates an application example of the connection clamp in accordance with the second embodiment of the present invention (II).

### DETAILED DESCRIPTION OF THE PREFERRED EMBODIMENT

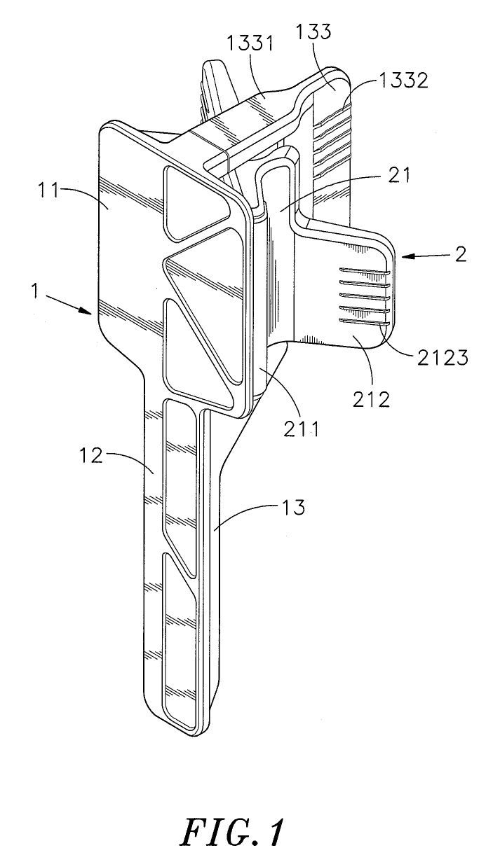

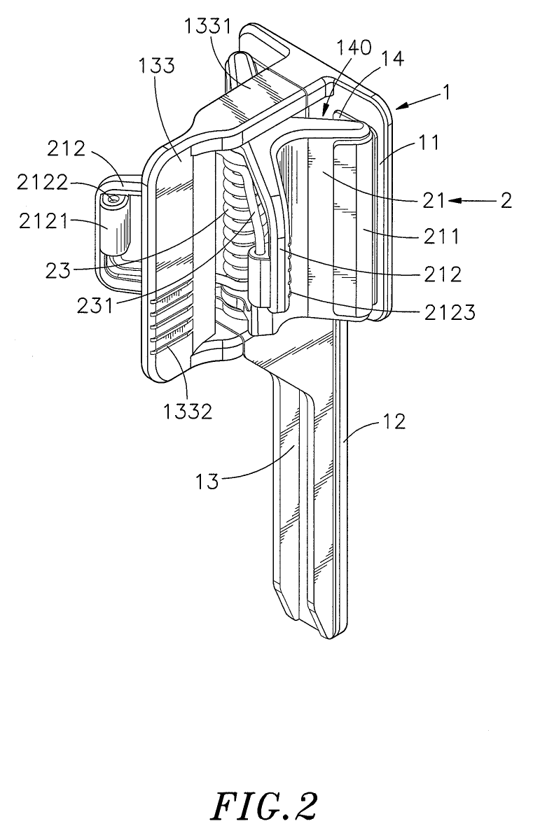

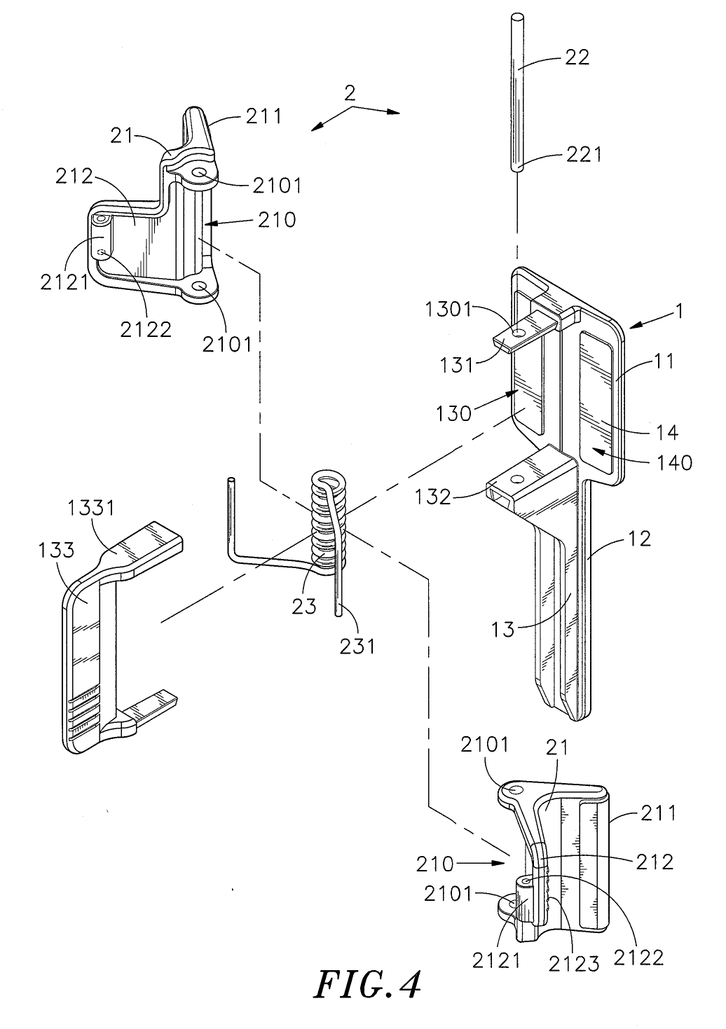

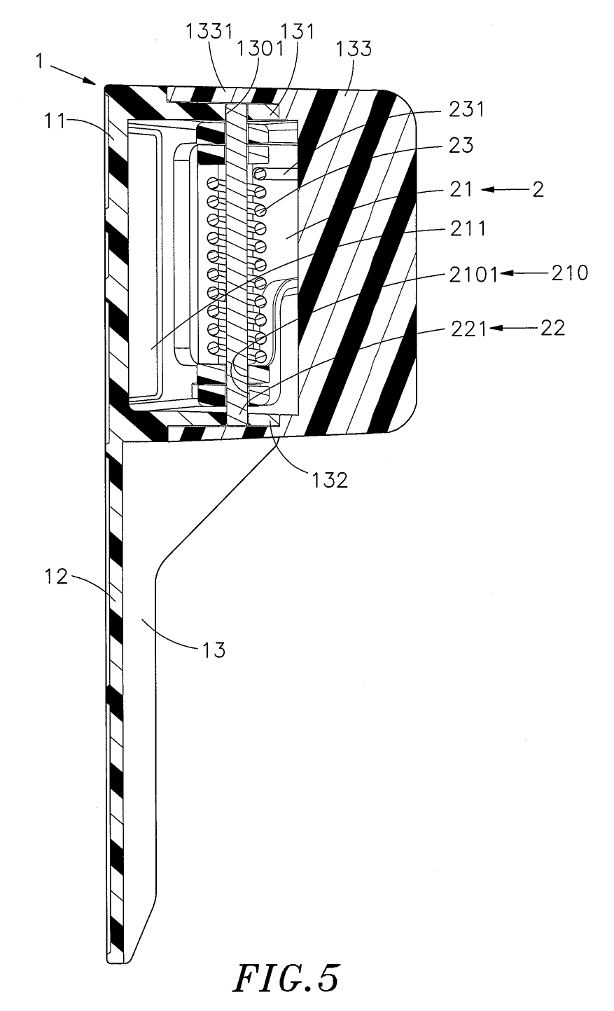

Referring to FIGS. 1-5, a connection clamp in accordance with a first embodiment of the present invention is shown. The connection clamp comprises a base member 1, and a clamping mechanism 2 mounted at one side of the base member 1.

The base member 1 comprises a rectangular bearing panel 11, a flat and elongated face panel 12 extended from a middle part of a bottom side of the rectangular bearing panel 11 in a flush manner, a bracket 13 located on a front side of the rectangular bearing panel 11 and a front side of the flat and elongated face panel 12 and defining an operating space 130 and two axle holes 1301 that are respectively disposed at opposing top and bottom sides of the operating space 130 and axially aligned in line, and two bearing surfaces 14 located on the front side of the rectangular bearing panel 11 at two opposite lateral sides relative to the operating space 130.

The clamping mechanism 2 comprises two clamping members 21 of V-shaped cross section, an axle 22 connecting the two clamping members 21, and a spring member 23. Each clamping member 21 comprises a clamping plate 211 and an operating plate 212 connected together to exhibit a substantially V-shaped cross section, a mounting space 210 defined in a back side thereof on the middle, two pivot holes 2101 respectively located on opposite top and bottom sides thereof in communication with the mounting space 210 and pivotally coupled to the axle 22, a locating block 2121 located on a distal end of a back side of the operating plate 212 remote from the pivot holes 2101, a hook hole 2122 defined in the locating block 2121, and anti-slip grooves 2123 located on an opposing front side of the operating plate 212. Further, the distance between the two pivot holes 2101 of one clamping member 21 is shorter than the distance between the two pivot holes 2101 of the other clamping member 21 so that the two clamping members 21 can be attached together to keep the pivot holes 2101 thereof in axial alignment. The axle 22 is pivotally inserted through the pivot holes 2101 of the two clamping members 21 and the spring member 23, having two opposing end portions 221 thereof respectively extended out of opposing top and bottom sides of the spring member 23. The spring member 23 has two angled end pieces 231 respectively extended from two opposite ends thereof in reversed directions and respectively hooked in the hook holes 2122 of the operating plate 212.

When assembling the connection clamp, insert the axle 22 through the pivot holes 2101 of the two clamping members 21 and the spring member 23 to pivotally connect the two clamping members 21 together and to hold the spring member 23 between the two clamping members 21, and then fasten the two end portions 221 of the axle 22 to the two axle holes 1301 of the bracket 13 of the base member 1 to mount the clamping mechanism 2 in the operating space 130 of the bracket 13. When assembled, the user can operate the operating plates 212 of the two clamping members 21 of the clamping mechanism 2 to move the clamping plates 211 toward or away from the respective bearing surfaces 14 of the rectangular bearing panel 11 of the base member 1.

Further, the back side of rectangular bearing panel 11 of the base member 1 and the back side of the elongated face panel 12 of the base member 1 are connected together in a flush manner, exhibiting a planar key-like shape; the back side of rectangular bearing panel 11 of the base member 1 opposite to the bearing surfaces 14 and the back side of the elongated face panel 12 are preferably configured to provide a decorative design. Further, the bracket 13 of the base member 1 comprises a supporting rod 131 and a supporting block 132 respectively and perpendicularly extended from the front side of the rectangular bearing panel 11 and the front side of the elongated face panel 12 and respectively disposed at opposing top and bottom sides between the two bearing surfaces 14, and a substantially U-shaped connection member 133 connected to the supporting rod 131 and the supporting block 132. The aforesaid operating space 130 is defined within the U-shaped connection member 133 between the two bearing surfaces 14 of the base member 1 for the positioning of the axle 22 and spring member 23 of the clamping mechanism 2. The aforesaid axle holes 1301 are respectively located on the supporting rod 131 and the supporting block 132 for receiving the two end portions 221 of the axle 22. After installation of the clamping mechanism 2 in the bracket 13 of the base member 1, the clamping plates 211 of the two clamping members 21 are respectively forced by the elastic potential energy of the spring member 23 to abut against the respective bearing surfaces 14 of the rectangular bearing panel 11, and the operating plates 212 of the two clamping members 21 are respectively suspended at two opposite sides relative to the U-shaped connection member 133. Further, the U-shaped connection member 133 comprises an anti-slip stripe design 1332 located on two opposite sides thereof, and two connection end pieces 1331 respectively extended from opposite top and bottom sides thereof and respectively fastened to the supporting rod 131 and the supporting block 132. Further, the connection between the supporting rod 131 and supporting block 132 of the bracket 13 and the connection end pieces 1331 of the U-shaped connection member 133 can be respectively achieved by means of a dovetail joint, tongue and groove joint, tenon and mortise joint or tight-fitting joint.

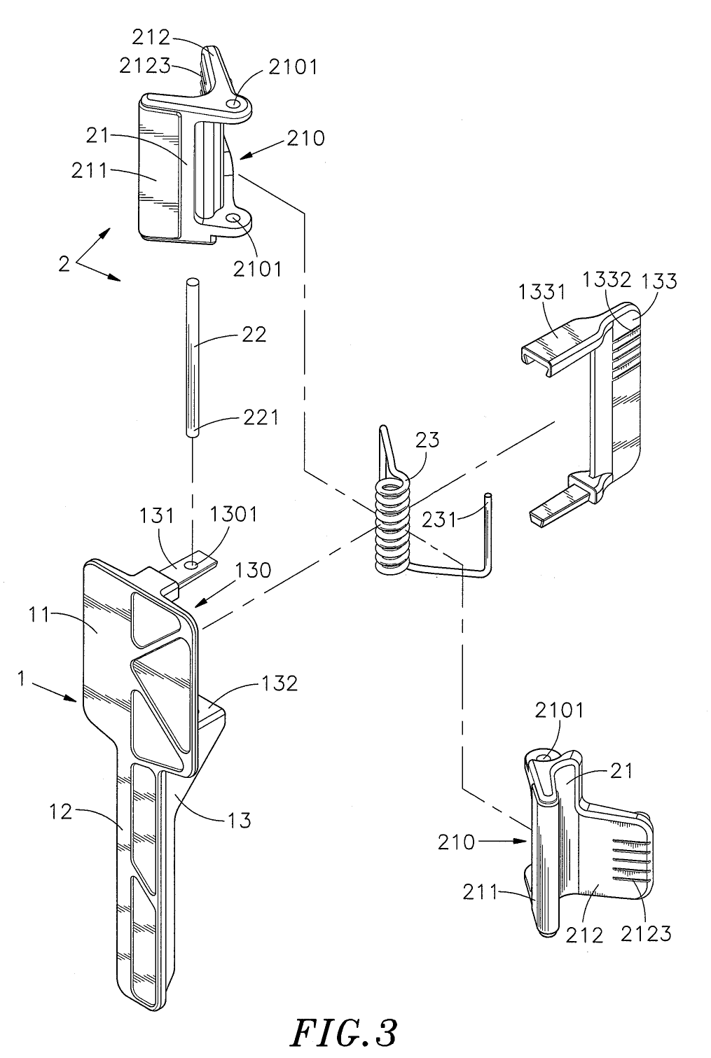

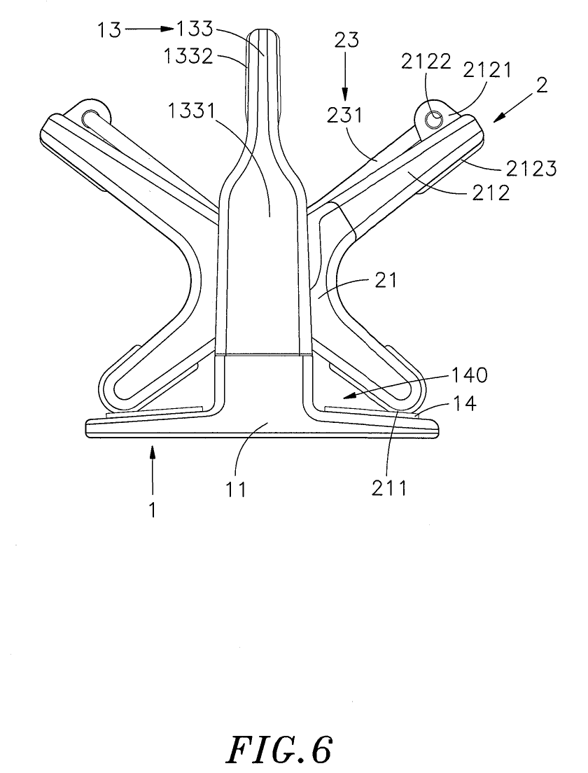

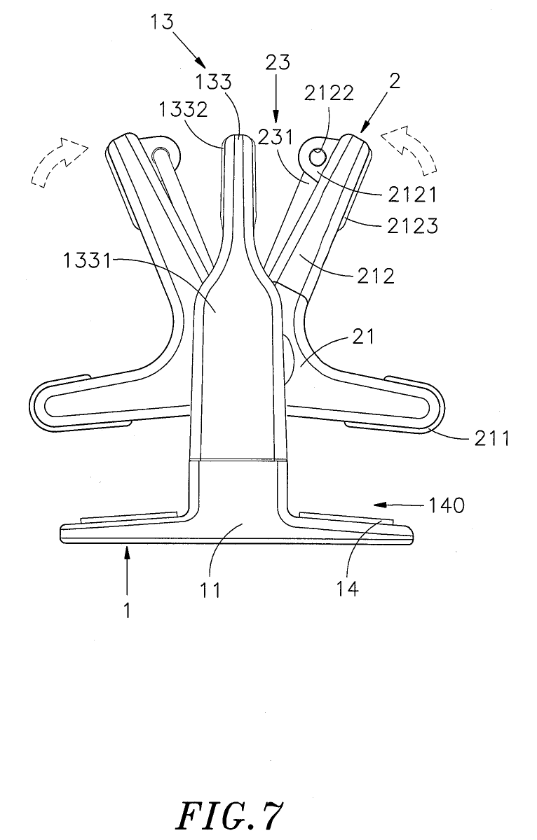

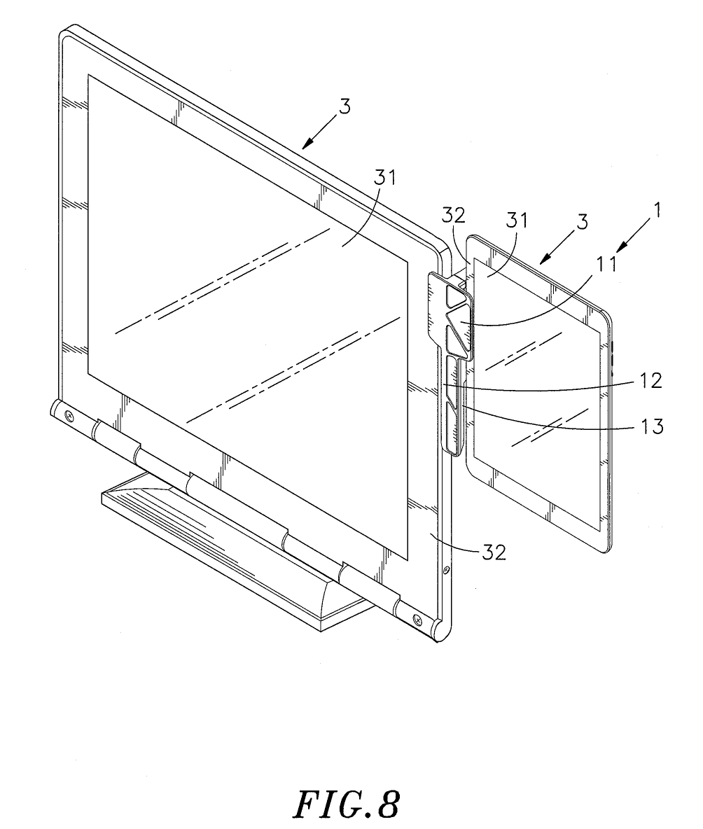

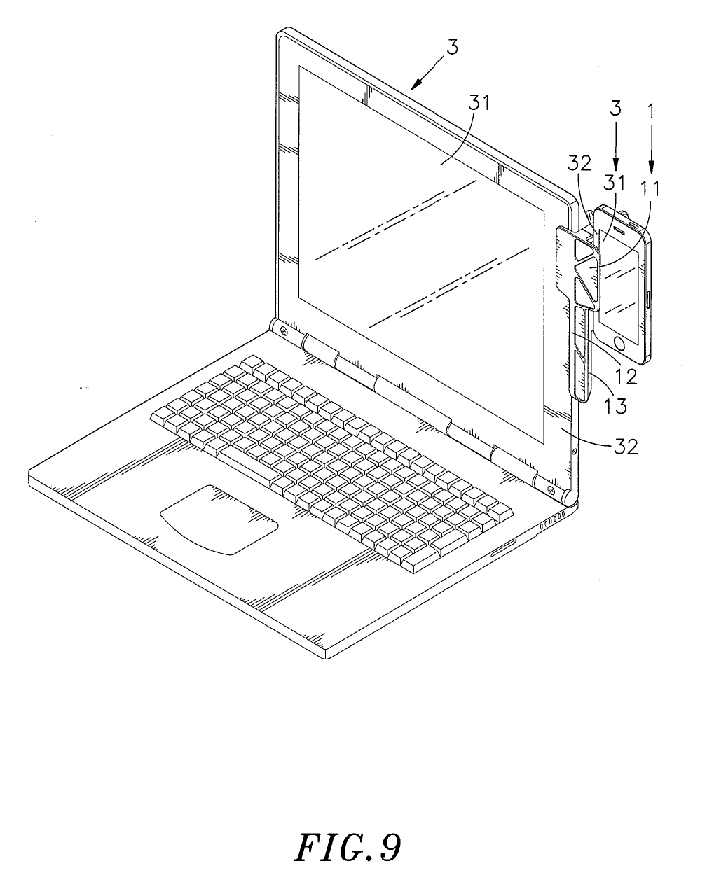

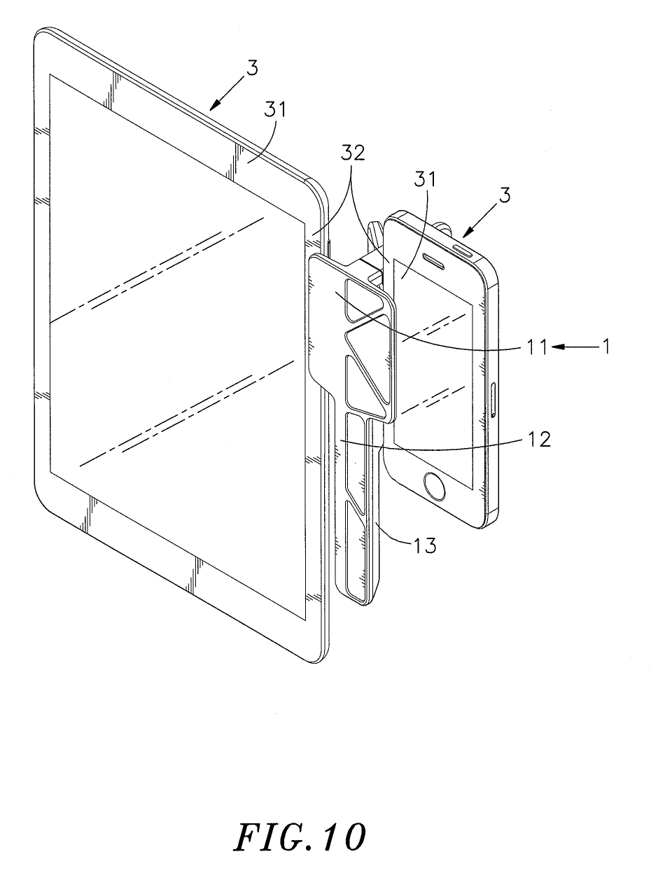

Referring to FIGS. 6-10 and FIGS. 3 and 4 again, when using the connection clamp, as illustrated, press the anti-slip grooves 2123 of the operating plate 212 of one clamping member 21 of the clamping mechanism 2 to bias the respective operating plate 212 toward the U-shaped connection member 133 and to simultaneous force one respective angled end piece 231 of the spring member 23 toward the U-shaped connection member 133, thereby moving the clamping plate 211 of the associated clamping member 21 away from the respective bearing surface 14 of the rectangular bearing panel 11. At this time, a clamping space 140 is defined between the said bearing surface 14 and the said clamping plate 211. Thereafter, attach this clamping space 140 to one lateral edge 32 of a flat mobile electronic device 3, and then release the pressure from the operating plate 212 of the clamping member 21, enabling the clamping plate 211 of the clamping member 21 to be forced by the respective angled end piece 231 of the spring member 23 to move the clamping plate 211 toward the respective bearing surface 14 of the base member 1, and thus, the respective lateral edge 32 of the flat mobile electronic device 3 around the screen 31 thereof is firmly secured in between the respective bearing surface 14 of the base member 1 and the clamping plate 211 of the respective clamping member 21. Thereafter, press the anti-slip grooves 2123 of the operating plate 212 of the other clamping member 21 of the clamping mechanism 2 to bias the respective operating plate 212 toward the U-shaped connection member 133 and to simultaneous force the other angled end piece 231 of the spring member 23 toward the U-shaped connection member 133, thereby moving the clamping plate 211 of the associated clamping member 21 away from the respective bearing surface 14 of the rectangular bearing panel 11. At this time, a clamping space 140 is defined between the said bearing surface 14 and the said clamping plate 211. Thereafter, attach this clamping space 140 to one lateral edge 32 of another flat mobile electronic device 3, and then release the pressure from the operating plate 212 of the clamping member 21, enabling the clamping plate 211 of the clamping member 21 to be forced by the respective angled end piece 231 of the spring member 23 to move the clamping plate 211 toward the respective bearing surface 14 of the base member 1, and thus, the respective bearing surface 14 of the base member 1 and the clamping plate 211 of the respective clamping member 21 are firmly clamped on the respective lateral edge 32 of the other flat mobile electronic device 3 around the screen 31 thereof. Thus, the connection clamp secure the two flat mobile electronic devices 3 is a side-by-side manner. Further, the flat mobile electronic devices 3 can be flat screens for desk top computer or TV, notebook computer screens, tablet computers, smart phones, PDAs and/or GPSs.

Further, one or multiple connection clamps can be mounted between each adjacent two flat mobile electronic devices of multiple flat mobile electronic devices 3, enabling the screens 31 of the flat mobile electronic devices 3 to be respectively clamped in the respective clamping spaces 140 between the respective bearing surfaces 14 of the respective base members 1 and the respective clamping plates 211 of the respective clamping mechanisms 2, and thus, the multiple flat mobile electronic devices 3 can be held side by side in the same plane. Further, the operation of the connection clamp is quite simple. Further, the decorative design of graphics, lines, and/or geometric pattern located on the back side of the rectangular bearing panel 11 and flat and elongated face panel 12 of the base member 1 makes the connection clamp more attractive. In one application example, the connection clamp is used to secure the screen 31 of a relatively smaller flat mobile electronic device 3, for example, tablet computer or smart phone to the screen 31 of a relatively larger flat mobile electronic device 3, for example, desktop computer or notebook computer, and thus, the user can simultaneously watch the screens 31 of two flat mobile electronic devices 3. Further, the connection clamp can be used to connect two flat mobile electronic devices 3 of different sizes side by side in the same plane, enabling the inner lateral edge 32 of the screen 31 of one relatively larger mobile electronic device 3 (for example, tablet computer) and the inner lateral edge 32 of the screen 31 of the other relatively smaller mobile electronic device 3 (for example, smart phone) to be clamped in the respective clamping spaces 140 between the respective bearing surfaces 14 of the base member 1 and the respective clamping plates 211 of the clamping mechanism 2, and thus, the user can watch the two screens 31 when playing a synchronous Internet game, holding a video conference, transmitting a short message, browsing the web, reading Internet data or making word processing works. By means of the connection clamp, two flat mobile electronic devices 3 can be connected side by side in the same plane for storage, preventing friction surface scratches due to stacking of flat mobile electronic devices 3.

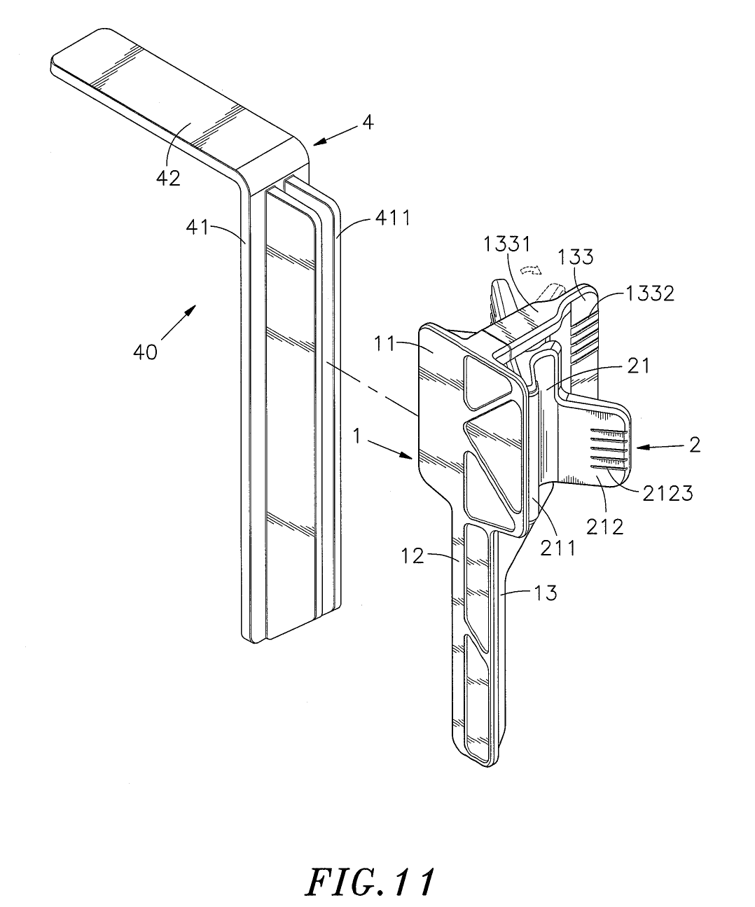

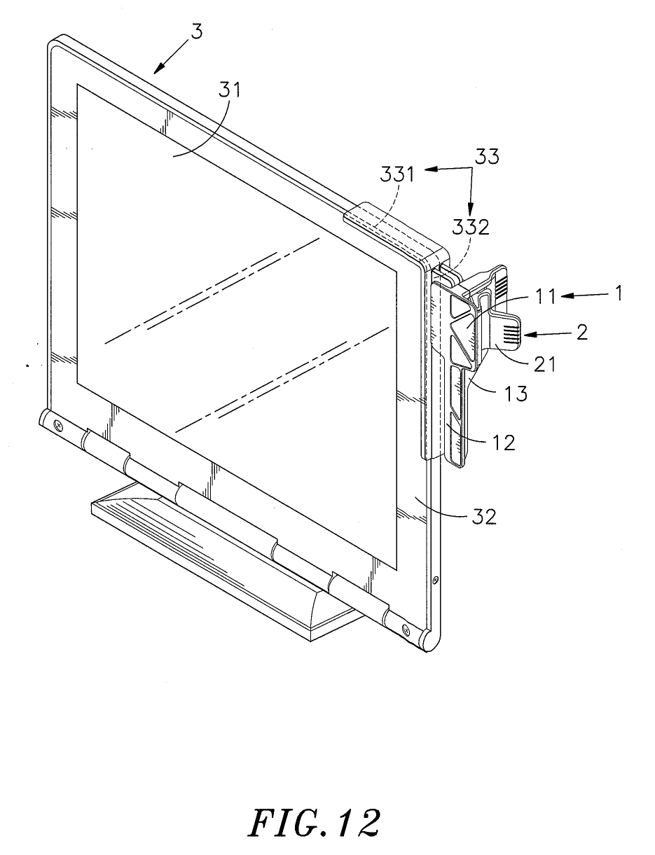

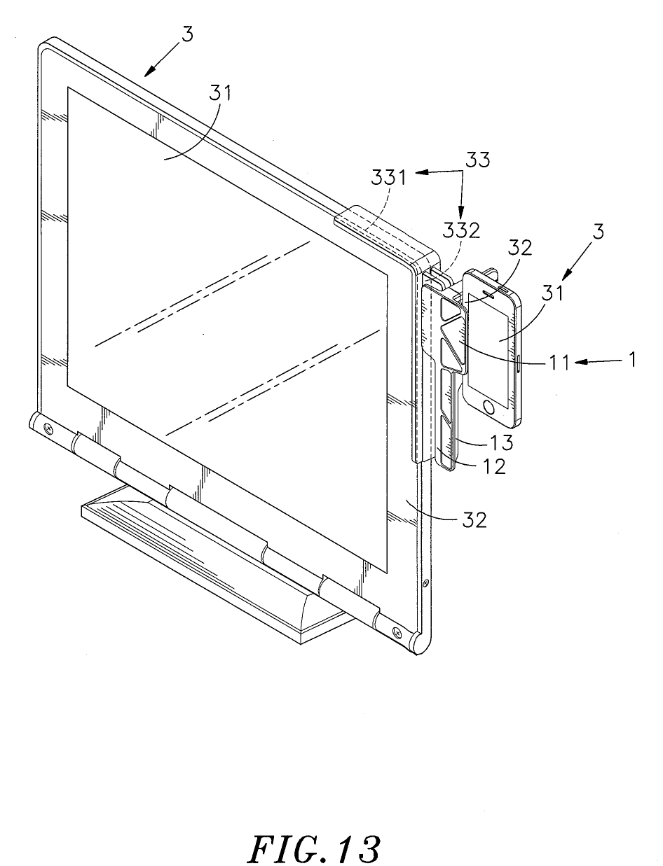

Referring to FIGS. 11-13, a connection clamp in accordance with a second embodiment of the present invention is shown. The connection clamp of this second embodiment is substantially similar to the aforesaid first embodiment with the exception of an extra L-shaped supplementary positioning member 4 that comprises a narrow elongated vertical panel 41 and a narrow elongated horizontal panel 42 connected at right angles, and a wind portion 411 located on a middle part of an outer wall of the narrow elongated vertical panel 41 and extended along the length thereof. Further, the narrow elongated vertical panel 41 and narrow elongated horizontal panel 42 of the L-shaped supplementary positioning member 4 define an inner positioning space 40. In application, press the anti-slip groove 2123 of the operating plate 212 of one clamping member 21 of the clamping mechanism 2 and the anti-slip stripe design 1332 of the U-shaped connection member 133 of the bracket 13 of the base member 1 to bias the respective operating plate 212 toward the respective U-shaped connection member 133 and to force the associated angled end piece 231 of the spring member 23 toward the U-shaped connection member 133, thereby moving the clamping plate 211 of the respective clamping member 21 away from the respective bearing surface 14 of the rectangular bearing panel 11. At this time, insert the wind portion 411 of the narrow elongated vertical panel 41 of the L-shaped supplementary positioning member 4 into the clamping space 140 between the bearing surface 14 and the clamping plate 211, and then release the pressure from the operating plate 212 of the clamping member 21, enabling the clamping plate 211 of the clamping member 21 to be forced by the respective angled end piece 231 of the spring member 23 toward the respective bearing surface 14 of the rectangular bearing panel 11 of the base member 1. Thus, the bearing surface 14 of the base member 1 and the clamping plate 211 of the respective clamping member 21 are clamped on the wind portion 411 of the narrow elongated vertical panel 41. Thereafter, press the anti-slip groove 2123 of the operating plate 212 of the other clamping member 21 of the clamping mechanism 2 and the anti-slip stripe design 1332 of the U-shaped connection member 133 of the bracket 13 of the base member 1 to bias the respective operating plate 212 toward the U-shaped connection member 133 and to force the associated angled end piece 231 of the spring member 23 toward the respective U-shaped connection member 133, thereby moving the clamping plate 211 of the respective clamping member 21 away from the respective bearing surface 14 of the rectangular bearing panel 11. At this time, insert the wind portion 411 of the narrow elongated vertical panel 41 of the L-shaped supplementary positioning member 4 into the clamping space 140 between the bearing surface 14 and the clamping plate 211, and then release the pressure from the operating plate 212 of the clamping member 21, enabling the clamping plate 211 of the clamping member 21 to be forced by the respective angled end piece 231 of the spring member 23 toward the respective bearing surface 14 of the rectangular bearing panel 11 of the base member 1. At this time, insert one lateral edge 32 of a flat mobile electronic device 3 (for example, smart phone or tablet computer) into the clamping space 140 between the bearing surface 14 and the clamping plate 211, and then release the pressure from the operating plate 212 of the clamping member 21, enabling the clamping plate 211 of the clamping member 21 to be forced by the respective angled end piece 231 of the spring member 23 toward the respective bearing surface 14 of the rectangular bearing panel 11 of the base member 1. Thus, the bearing surface 14 of the base member 1 and the clamping plate 211 of the respective clamping member 21 are clamped on the lateral edge 32 of the flat mobile electronic device 3. Thereafter, attach the inner positioning space 40 of the L-shaped supplementary positioning member 4 to one upper corner 33 of another flat mobile electronic device 3 (for example, desktop computer, notebook computer or TV screen) enabling the narrow elongated vertical panel 41 and narrow elongated horizontal panel 42 of the L-shaped supplementary positioning member 4 to be respectively secured to the one vertical side edge 332 and the horizontal top edge 331 of the flat mobile electronic device 3, and thus, the two flat mobile electronic devices 3 are secured together side by side in the same plane by the bearing surfaces 14 of the base member 1, the clamping plates 211 of the respective clamping member 21 of the clamping mechanism 2 and the L-shaped supplementary positioning member 4.

As illustrated, the operating space 130 is defined in the front side of the base member 1; the two bearing surfaces 14 are located on the front wall at two opposite lateral sides relative to the operating space 130; the clamping mechanism 2 is mounted in the operating space 130 of the base member 1. By means of pressing the operating plate 212 of one clamping member 21 of the clamping mechanism 2, the clamping plate 211 of the respective clamping member 21 is biased away from the respective bearing surface 14 of the base member 1 with the respective clamping space 140 opened between the respective bearing surface 14 and the respective clamping plate 211 for clamping. Thus, the connection clamp can be used to secure two flat mobile electronic devices 3 side by side in the same plane for watching in an application, or for storage to prevent friction scratches.

In conclusion, the invention provides a connection clamp, which comprises a base member and a clamping mechanism. The base member comprises an operating space defined in a middle part of a front side thereof, and two bearing surfaces disposed at two opposite lateral sides relative to the operating space. The clamping mechanism comprises two clamping members pivotally mounted in the operating space of the base member at two opposite lateral sides, an axle mounted in the operating space to pivotally connect the two clamping members together, and a spring member mounted around the axle and adapted to force the two clamping members into abutment against the respective bearing surfaces of the base member. Further, each clamping member comprises a clamping plate forced by the spring member to clamp on one respective bearing surface of the base member, and an operating plate extended from the clamping plate at a predetermined angle and operable to bias the clamping plate away from the respective bearing surface.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A connection clamp, comprising:
a base member comprising an operating space defined in a middle part of a front side thereof, and two bearing surfaces disposed at two opposite lateral sides relative to said operating space; and
a clamping mechanism comprising two clamping members pivotally mounted in said operating space of said base member at two opposite lateral sides, an axle mounted in said operating space to pivotally connect said two clamping members together and a spring member mounted around said axle and adapted to force said two clamping members into abutment against the respective said bearing surfaces of said base member, each said clamping member comprising a clamping plate forced by said spring member to clamp on one respective said bearing surface of said base member and an operating plate extended from said clamping plate at a predetermined angle and operable to bias said clamping plate away from the respective said bearing surface.

2. The connection clamp as claim in claim 1, wherein said base member comprises a bracket located on the front side thereof; said operating space is defined in said bracket; said axle of said clamping mechanism is inserted through said spring member, having two end portions respectively extended out of opposing top and bottom sides of said spring member and respectively connected to opposing top and bottom sides of said bracket.

3. The connection clamp as claim in claim 2, wherein said bracket comprises a supporting rod and a supporting block respectively perpendicularly extended from the front side of said base member at opposing top and bottom sides of said operating space, two axle holes respectively vertically located on said supporting rod and said supporting block and axially aligned in line and a U-shaped connection member connected to said supporting rod and said supporting block; said axle is connected between said supporting rod and said supporting block with the two end portions thereof respectively fastened to said two axle holes.

4. The connection clamp as claim in claim 3, wherein said U-shaped connection member comprises two connection end pieces respectively extended from opposing top and bottom sides thereof and respectively fastened to said supporting rod and said supporting block, and an anti-slip stripe design located on two opposite lateral sides thereof.

5. The connection clamp as claim in claim 1, wherein said base member comprises a rectangular bearing panel, a flat and elongated face panel extended from a middle part of a bottom side of said rectangular bearing panel and a decorative design of graphics, lines, and/or geometric pattern located on an opposing back side thereof, said rectangular bearing panel and said flat and elongated face panel being connected together in a flush manner to exhibit a planar key-like shape.

6. The connection clamp as claim in claim 1, wherein said clamping members of said clamping mechanism have a substantially V-shaped cross section, each said clamping member defines a mounting space in a back side thereof on the middle for accommodating said spring member.

7. The connection clamp as claim in claim 6, wherein each said clamping member further comprises two pivot holes respectively disposed at opposing top and bottom sides of the mounting space thereof, and a hook hole located on the operating plate thereof; said two end portions of said axle are respectively pivotally inserted through the two pivot holes of each said clamping member and respectively fastened to said base member to pivotally connect said two clamping members to said base member; said spring member is mounted around said axle in said mounting space of each said clamping member, comprising two angled end pieces respectively extended from two opposite ends thereof and respectively hooked in the said hook holes of said two clamping members.

8. The connection clamp as claim in claim 7, wherein each said clamping member further comprises a locating block located on a distal end of a back side of the operating plate thereof; the hook hole of each said clamping member is defined in said locating block of the respective said clamping member; said angled end pieces of said spring member extend in reversed directions and are respectively hooked in the said hook holes in the respective said locating blocks of the respective said clamping members.

9. The connection clamp as claim in claim 6, wherein each said clamping member further comprises a plurality of anti-slip grooves respectively located on the operating plate thereof.
